(19) United States
(12) Patent Application Publication
(10) Pub. No.: US 2014/0154360 A1
(43) Pub. Date: Jun. 5, 2014

(54) METHOD FOR PRODUCING A MARKED MEAT PRODUCT

(71) Applicant: Helmut Stolzenhoff, Luenen (DE)

(72) Inventor: Helmut Stolzenhoff, Luenen (DE)

(73) Assignee: Fleischerei und Party-Service stolzenhoff GmbH & Co. KG, Luenen (DE)

(21) Appl. No.: 14/128,743

(22) PCT Filed: Jun. 12, 2012
(86) PCT No.: PCT/EP2012/002477

§ 371 Date: Jan. 31, 2014

(30) Foreign Application Priority Data
Jun. 24, 2011 (DE) 10 2011 105 741.6

(51) Int. Cl. A23L 1/317

(52) U.S. Cl. CPC A23L 1/3172
USPC 426/87; 426/250

(57) ABSTRACT

The invention relates to a method for producing a marked meat product. In order to provide a novel method for producing a marked meat product, which makes it possible to produce different marked meat products in a simple manner, wherein the enjoyment of consuming the meat products is not mitigated by the mark thereon, it is proposed with this invention that initially, an edible film is imprinted with food coloring. Subsequently, the imprinted film is applied to a quantity of meat, and finally, the meat, with the film applied thereto, is cooked.

The invention relates to a method for the production of an imprinted meat product.

It is known to label food wrappings or to provide them with decorative patterns. This is disclosed, for example, by DE 30 13 320 A1.

It is the task of the invention to make available a novel method for the production of an imprinted meat product, which allows the production of meat products imprinted in the most varied ways, in simple manner, whereby enjoyment during consumption of these meat products is not impaired by their imprinting.

This task is accomplished, in a method of the type stated initially, in that first, an edible film is imprinted with food-grade ink, then the imprinted film is applied to the meat mass, and last, the meat mass, with the film applied to it, is fried/roasted.

According to the method according to the invention, an imprinted meat product can thereby be produced, in which the crust produced on the meat mass during frying/roasting forms a unit with the imprinted edible film that is also fried/roasted, so that when consuming the meat product, it is no longer evident that an edible imprinted film is present on the meat mass. Instead, the edible imprinted film combines with the crust that occurs on the meat mass during frying/roasting, in such a manner that a very crispy mantling of the meat mass occurs, which increases enjoyment during consumption of the imprinted meat product produced in this manner. The imprinted meat product is thereby improved by the placement of the edible imprinted film. Frying/roasting of the composite of meat mass and edible imprinted film is preferably carried out in such a manner that the imprinting, in other words the label disposed on the edible film or the motif imprinted on it, is maintained, thereby forming the imprinted meat product.

The most varied types of labels and motifs are possible as imprinting. For example, the logo of a sports team, particularly a soccer team, can be used as a motif.

The meat mass can be present as a piece of meat that has grown in one piece or as chopped meat. The latter can be mixed with spices, binders, flavor enhancers, and additional fats.

According to an advantageous embodiment of the invention, a collagen film is used as the edible film. This material selection particularly promotes the production of a pleasantly crispy mantling of the fried/roasted meat mass, produced during frying/roasting.

An advantageous embodiment of the invention provides that frying/roasting takes place at a temperature of about 175° C. It has turned out that this temperature selection is suitable for bringing about an optimal bond between the imprinted edible film and the meat mass during frying/roasting, and at the same time maintaining the imprinting. The duration of the frying/roasting process is determined by the weight of the meat mass to be fried/roasted. If, for example, an imprinted meat product is supposed to be produced in the form of an imprinted meat patty, then frying can last for about 20 minutes.

It is further considered advantageous if frying/roasting takes place without any addition of moisture.

According to a further advantageous embodiment of the invention, the imprinted film is applied to the meat mass by means of a press. In this way, a whole-area bond between meat and film is produced.

It is advantageous if the meat mass, together with the imprinted film applied to it, is shaped into a meat product pre-form before frying/roasting. For example, the meat mass, together with the imprinted film applied to it, can be shaped into a pre-form for a meat patty, a sausage, or the like. Also, it is possible that a specific amount of meat mass is punched out of a larger amount of meat mass, together with the imprinted film disposed on the entire meat mass. In this connection, it can be provided that a large-area edible film is imprinted with a great number of motifs disposed next to one another, whereby the amount of meat mass disposed under one of these motifs, in each instance, is punched out of the entire meat mass, together with the film section that has one of the motifs.

Furthermore, it is proposed that a meat mass is used that comprises a composition for the production of a meat product in the form of a meat patty. The meat mass for a meat patty can contain, for example, pork, beef, bacon, breadcrumbs, bouillon, cooking salt, spices, emulsifiers, and dextrose.

With the invention, an imprinted meat product is furthermore proposed, which is configured in accordance with one of the embodiments described above and any desired combination of same. The advantages mentioned above are connected with this. Preferably, the imprinted meat product is configured as an imprinted meat patty.

In the following, an exemplary embodiment for the method according to the invention is given:

The collagen film of the company Viscofan BioEngineering, Weinheim, which is known as “Naturin collagen film,” is used as the film. Imprinting of the film is carried out using a suitable machine. In this connection, the food-grade inks

black (composition: water; ethanol; carrier substance: propylene glycol E1520; pigments: azorubine E122, brilliant blue FCF E133, tartrazine E102),

yellow (composition: water; ethanol; carrier substance: propylene glycol E1520; pigments: tartrazine E102, cochineal red A E124),

magenta (composition: water; ethanol; carrier substance: propylene glycol E1520; pigments: azorubine E122, cochineal red A E124), and

cyan (composition: water; ethanol; carrier substance: propylene glycol E1520; pigments: brilliant blue FCF E133, indigotine I E132)

can be used. A meat patty mass composed of pork, beef, bacon, breadcrumbs, bouillon, cooking salt, spices, emulsifiers, and dextrose is used as the meat mass. The imprinted film is laid onto the freshly prepared meat patty mass and brought into the appropriate shape using a Salisbury steak maker. Afterward, the meat patty (raw weight approx. 110 g) is fried in a combination steamer, without adding any moisture, at 175° C. for approx. 20 min. After the cooking time has elapsed, the meat patty and the imprinted collagen film have become a composite that can be consumed without any impairment of flavor. The film results in a crispy effect.

1. Method for the production of an imprinted meat product, wherein first, an edible film is imprinted with food-grade ink, then the imprinted film is applied to a meat mass, and last, the meat mass, together with the film applied to it, is fried/roasted.

2. Method according to claim 1, wherein the meat mass, together with the imprinted film applied to it, is fried/roasted in such a manner that the imprinting is maintained.

3. Method according to claim 1, wherein a collagen film is used as the edible film.

4. Method according to claim 1, wherein frying/roasting takes place at a temperature of about 175° C.

5. Method according to claim 1, wherein frying/roasting takes place without addition of moisture.

6. Method according to claim 1, wherein the imprinted film is applied to the meat mass by means of a press.

7. Method according to claim 1, wherein the meat mass, together with the imprinted film applied to it, is shaped into a meat product pre-form before frying/roasting.

8. Method according to claim 1, wherein a meat mass is used that comprises a composition for the production of a meat product in the form of a meat patty.

9. Imprinted meat product, wherein it is produced according to the method according to claim 1.

10. Imprinted meat product according to claim 9, wherein it is configured as an imprinted meat patty.
